(19) United States
(12) Patent Application Publication
(10) Pub. No.: US 2006/0010325 A1
(43) Pub. Date: Jan. 12, 2006

(54) Security system for computer transactions

(75) Inventors: Ningjun Liu, King of Prussia, PA (US); Glenn W. Eastlack, King of Prussia, PA (US)

Correspondence Address: MILLER LAW GROUP, PLLC, 25 STEVENS AVENUE, WEST LAWN, PA, 19609, US

(73) Assignee: Devon IT, Inc.

(21) Appl. No.: 10/888,328

(22) Filed: Jul. 9, 2004

(51) Int. Cl. H04L 9/00

(52) U.S. Cl. 713/173

(57) ABSTRACT

A Security system for computer transactions incorporates a USB Security Key, a remote terminal and a secure access appliance to provide Security for a central computer. The USB Security Key is coded with a personal digital certificate and is required to be inserted into the remote terminal, along with the input of a personal identification number, before communications with the secure access appliance can be authenticated. The remote terminal is provided only with a central processing unit, random access memory, and restricted access, non-volatile flash memory storage device, which when used with a central computer, eliminates the need to store data on a permanent memory storage device. Software applications can be downloaded from the central computer for operation by the remote terminal. Since the IP address/name of the central computer is hidden by the secure access appliance, the central computer remains secure from unauthorized access and provides an audit trail.

### BACKGROUND OF THE INVENTION

The present invention relates generally to transactions being conducted by computer, such as via the Internet, and, more particularly, to a system by which the transactions can remain secure.

The Internet has brought many advantages in communications to its users, but has also brought substantial security concerns along with those advantages. Hackers gain access to private records of individuals and of corporations and governmental agencies through their connection to the Internet. Identity theft has become a buzzword for a major crime in which a person's secret account numbers, access codes, social security numbers, and other related information are stolen from a person and used to charge purchases, transfer finds, etc. from the person rightfully entitled thereto. Such theft is usually the result of a theft of the information from an owner's computer. Each transaction in which secret information of the owner is transmitted to a third party becomes subject to invasion by a hacker.

Once a hacker has access into a person's computer, the electronic files in conventional Windows programs wherein account numbers and passwords are located are easily identified and opened. Access into corporate main computers is initiated by having the IP address/name for the computer. Authentication of the person accessing the files again lies in the user name and password. Even where passwords are frequently changed, authentication remains relatively insecure and, yet is expensive to maintain, because users often utilize easy to guess passwords.

Personal digital certificates are electronic files that serve as an online passport for an Internet user. The digital certificates are issued by a trusted third party, commonly referred to as a certificate authority, which verifies the identity of the holder of the certificate. Digital certificates are tamper-proof and cannot be forged. A mini-form computer is a cost effective alternate to standard personal computers because of lower Mean Time Between Failures (MTBF) due to no moving parts such as a hard drive, although the mini-form computer will incorporate a central processing unit (CPU) and the transient memory associated therewith. A mini-form computer relies on a remote main computer for storage of programs and data. A NTA USB Security Key is a device that can be inserted into the USB port of a computer to identify information about the identity of the user of the computer. USB keys are available through technology developed by Giesecke & Devrient of Germany.

Banks, for example, have a need to provide secure access into the data on their mainframe computers for their customers who want to do online banking or other financial transactions. Utilizing a standard personal computer in which the access information, such as IP address, account number and password, is stored to permit access to the bank's mainframe causes substantial security concern. Whether the person accessing the bank's mainframe is bank personnel or customers, security is a primary concern. Other corporate and industrial environments have similar need for utilization of a central computer for accessing data therein without endangering security for the central computer.

It would be desirable to provide a system in which a remote access to a central computer can be attained without a risk for the breaching of security of the central computer. It would also be desirable to provide a system for accessing a central computer in which a secure audit trail is maintained to permit an audit of transactions involving the central computer.

### SUMMARY OF THE INVENTION

It is an object of this invention to overcome the aforementioned disadvantages of the known prior art by providing a system for providing secure access to a central computer.

It is another object of this invention to provide a secure, Web-browser based access to a wide range of data-center resources.

It is a feature of this invention that the security system integrates into an existing network infrastructure.

It is an advantage of this invention that the security system can work with an array of applications.

It is another advantage of this invention that security system secures multi-application remote-access environments.

It is another advantage of this invention that the security system does not require software installation and, therefore, simplifies deployment.

It is another feature of this invention that increased security is obtained by requiring both a digital certificate and a personal identification number to gain access to the central computer.

It is still another advantage of this invention that the digital certificate is embedded in a USB Security Key that provides a hard key to gain access to a central computer.

It is yet another feature of this invention that the local terminal can be a mini-form computer with a restricted access, non-volatile flash memory storage device in place of a hard drive.

It is still another feature of this invention that the remote user can display and utilize software applications stored on the central computer.

It is yet another feature of this invention that the communications between the remote user and a central appliance can be encrypted.

It is yet another feature of this invention that data transfer speed between the remote user and a central appliance can be adapted to the client device capabilities, network bandwidth and network load.

It is yet another advantage of this invention that management of the remote users can be centralized at the central computer.

It is a further advantage of this invention that a single integrated turnkey security system is provided without requiring a piecing together of a myriad of diverse technologies.

It is still another object of this invention to provide an ability to access any software application without installing the software on the remote computer.

It is yet another object of this invention to provide a security solution for computer transactions that integrates seamlessly into existing network and security infrastructures, while offering rapid deployment, easy installation, minimal maintenance and unparalleled network protection.

These and other objects, features and advantages are accomplished according to the instant invention by providing a security system for computer transactions that incorporates a USB Security key, a remote terminal and a secure access appliance to provide unparalleled Security for a central computer. The USB Security Key is coded with a personal digital certificate and is required to be inserted into the remote terminal, along with the input of a personal identification number, before communications with the secure access appliance can be authenticated. The remote terminal is provided only with a central processing unit, random access memory, and restricted access, non-volatile flash memory storage device, which when used with a central computer, eliminates the need to store data on a permanent memory storage device. Software applications can be downloaded from the central computer for operation by the remote terminal. Since the IP address/name of the central computer is hidden by the secure access appliance, the central computer remains secure from unauthorized access. The secure access appliance also provides an audit trail for auditing transactions to the central computer.

### BRIEF DESCRIPTION OF THE DRAWINGS

The foregoing and other objects, features, and advantages of the invention will appear more fully hereinafter from a consideration of the detailed description that follows, in conjunction with the accompanying sheets of drawings. It is to be expressly understood, however, that the drawings are for illustrative purposes and are not to be construed as defining the limits of the invention.

FIG. 1 is a schematic diagram of a security system for a central computer incorporating the principles of the instant invention;

FIG. 2 is a schematic diagram of the components of the security system incorporating the principles of the instant invention;

FIG. 3 is a logic flow diagram of the remote terminal authentication procedure;

FIG. 4 is a logic flow diagram of the secure access appliance authentication procedure following the granting of access to the remote terminal; and

FIG. 5 is a logic flow diagram of the procedure for the user to launch an application from the central computer.

### DETAILED DESCRIPTION OF THE PREFERRED EMBODIMENT

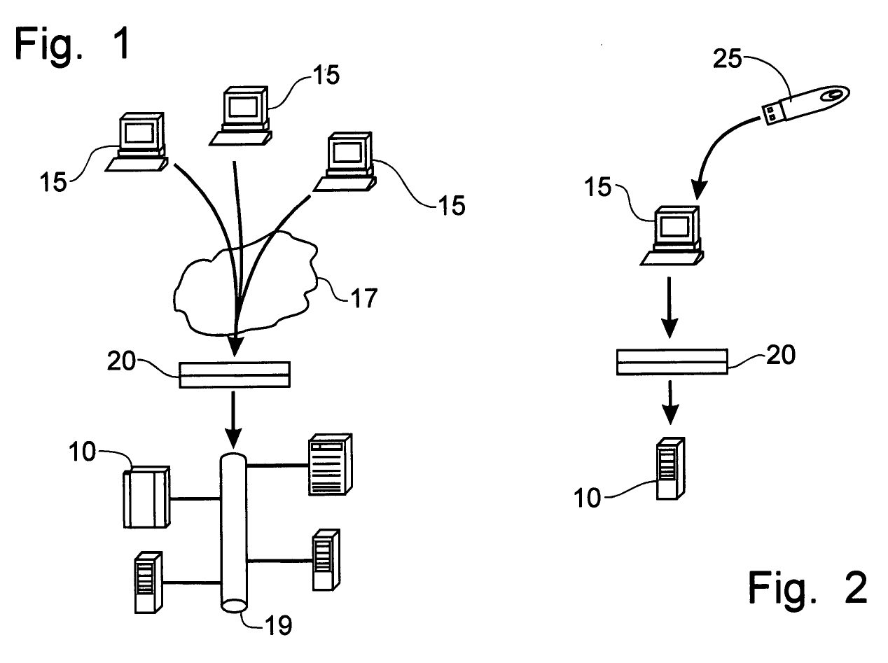

Referring to FIGS. 1 and 2, a security solution for computer transactions can best be seen. The central computer 10 stores all of the software, other than the operating software needed to operate the remote terminal 15, required for use at the remote terminal 15, as well as all data. The remote terminal 15 is preferably a mini-form computer having a restricted access, non-volatile flash memory storage device [GE2], a central processing unit (CPU), and random access memory (RAM) that is required for use of the remote terminal 15. Between the remote terminal 15 and the central computer 10 is a secure access appliance 20 through which all communications to the central computer 10 must pass. The remote terminals 15 access the secure access appliance 20 through a network 17, which can be the Internet, an Intranet, a local area network (LAN), or a wide area network (WAN), for example. The secure access appliance 20 protects the IP address of the central computer from identification through the network 17 by either the remote users at the terminals 15 or third party individuals seeking access into the central computer 10.

The remote terminal 15 provides a cost effective alternative to standard personal computers. The terminal preferably contains an optimized Red Hat Linux distribution. Using the “Server Centric Computing” paradigm, the remote terminal minimizes the cost of support by a centralized management. Since the remote terminal 15 requires no software, other than the operating system software, deployment of the remote terminal 15 is substantially simplified. When connected through the secure access appliance 20, the remote terminal 15 is operable to display any software application stored in the central computer 10, and thus is fully functional. Maintenance of the remote terminal 15 is also simplified by the lack of hard drive as the remote terminal 15 will have fewer moving parts to fail.

The USB Security Key 25 provides an encrypted secure passport for access to the secure access appliance 20. The USB Security Key 25 eliminates the need for password authentication by having a personal digital certificate embedded within the key 25. When the remote user desires to access a restricted resource, such as the secure access appliance 20, the user must first plug the USB Security Key 25 into a USB port on the remote terminal 15. The user must input a personal identification number to access the personal digital certificate, but once activated, the personal digital certificate serves as a passport for communications through the secure access appliance 20 into the central computer 10. The digital certificate is issued by a trusted third party, certificate authority that verifies the identity of the certificate's holder. The USB Security Key 25 is tamper-proof and cannot be forged.

The secure access appliance 20 enables the system to securely extend critical applications to remote users through a thin browser-based client. These critical applications can be Microsoft® Windows®, UNIX®, Linux®, Java®, Mainframe and AS/400® applications. Access to the secure access appliance 20 is restricted only to authenticated users utilizing a USB Security Key 25. If an unauthenticated user attempts to access the secure access appliance 20, the user could alternatively be presented with a logon page, which would enable access via RSA SecurID® token, or even a user name and password, if so desired. The secure access appliance 20 can authenticate the user name and password against users stored in a variety of different data sources including Unix passwords, Microsoft Active Directory, Microsoft Windows Domains, and LDAP.

If the personal digital certificate is presented through a USB Security Key 25, the remote user is passed into the secure access appliance 20. The secure access appliance 20 communicates with the application servers, or central computer 10, using native protocols 19 such as RPD, X11, 3270, telnet, etc., as is depicted in FIG. 1. The secure access appliance 20 then converts these protocols into Adaptive Internet Protocol (AIP), which is then sent to a Java applet running in the remote user's browser at the remote terminal 15. AIP is made secure by being transmitted over a Secure Socket Layer (SSL) connection.

By combining the utilization of the USB Security Key 25, the secure access appliance 20, and the mini-form remote terminal into a single holistic approach, a system is created that ensures an ease of installation and guarantees user identity. The secure access appliance 20 can be used to easily and securely extend software applications to both internal and remote users of the system. The remote terminal 15 will permit access to any software applications hosted on the secure access appliance 20. As an added measure of security, both the secure access appliance 20 and the remote terminal 15 can be integrated with the USB Security Key 25 for authentication purposes, as is depicted in FIG. 2.

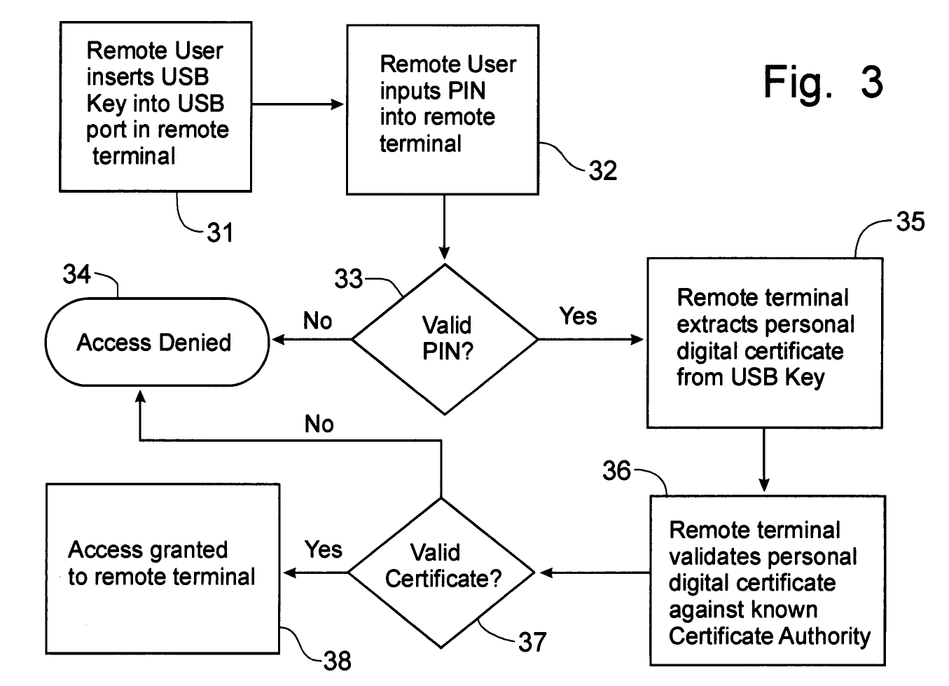

Referring to FIGS. 3-5, the operation of the security system can best be seen. The remote terminal 15 and the secure access appliance 20 are configured so that the remote user must use the USB Security Key 25 in order to gain access to either the remote terminal 15 or the secure access appliance 20. The remote terminal 15 authentication procedure is depicted in FIG. 3. To logon to the remote terminal 15, the remote user must first insert the USB Security Key 25 into an open USB port in the remote terminal 15, as indicated at step 31, and then enter a personal identification number (PIN), as indicated at step 32. If the inputted PIN matches the PIN stored in the USB Security Key 25, per the query at step 33, the remote terminal 15 then extracts the personal digital certificate stored in the USB Security Key 25. If the inputted PIN is not valid, access to the remote terminal 15 is denied at step 34.

With the extraction of the personal digital certificate from the USB Security Key 25, the remote terminal 15 then validates the personal digital certificate against the known Certificate Authority issuing the certificate via communication over the internet, as indicated at step 36. If the Certificate Authority validates the personal digital certificate, at query 37, access to the remote terminal 15 is granted to the remote user, as indicated at step 38. In the event the personal digital certificate is not validated at query 37, access to the remote terminal 15 is denied at step 34.

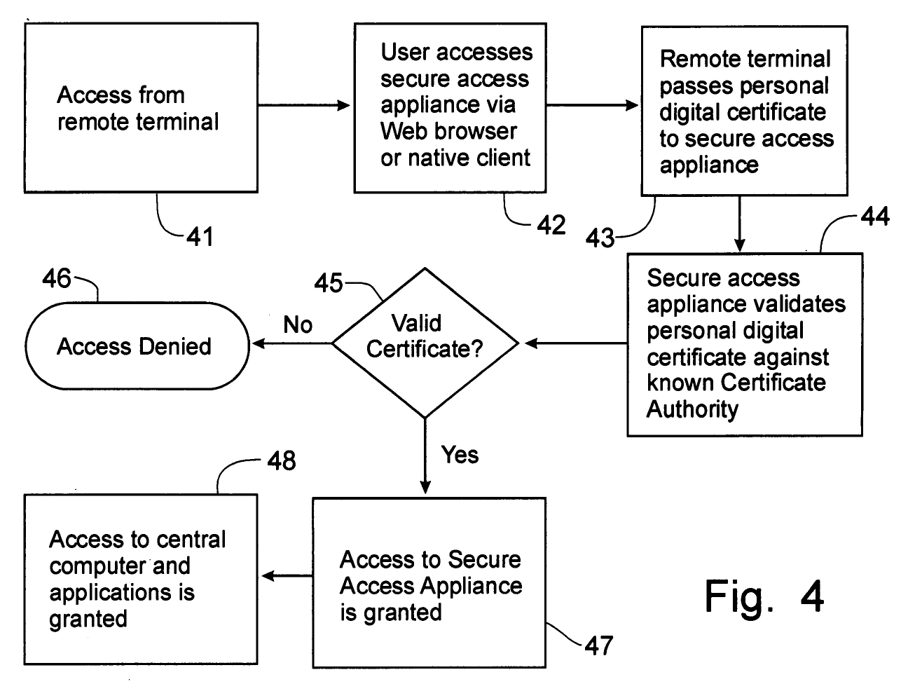

When the remote user then attempts to access the secure access appliance 20 via the network 17, whether the network 17 is the internet, an intranet, a LAN or a WAN, the user's authenticated personal digital certificate is automatically forwarded to the secure access appliance 20 for authentication, as is indicated at steps 41-43 in FIG. 4. The forwarding of the personal digital certificate to the secure access appliance 20 is completely seamless to the remote user. Therefore, the remote user is only required to logon once to the remote terminal 15 and all further authentication requests and queries are handled in the background. At step 44, the secure access appliance 20 further authenticates the personal digital certificate against the known Certificate Authority. If not validated at query 45, access to the secure access appliance is denied at step 46. If validated at the query 45, access to the secure access appliance 20 is granted at step 47 and the remote user is then granted access to the central computer 10 or other application servers through the appliance 20.

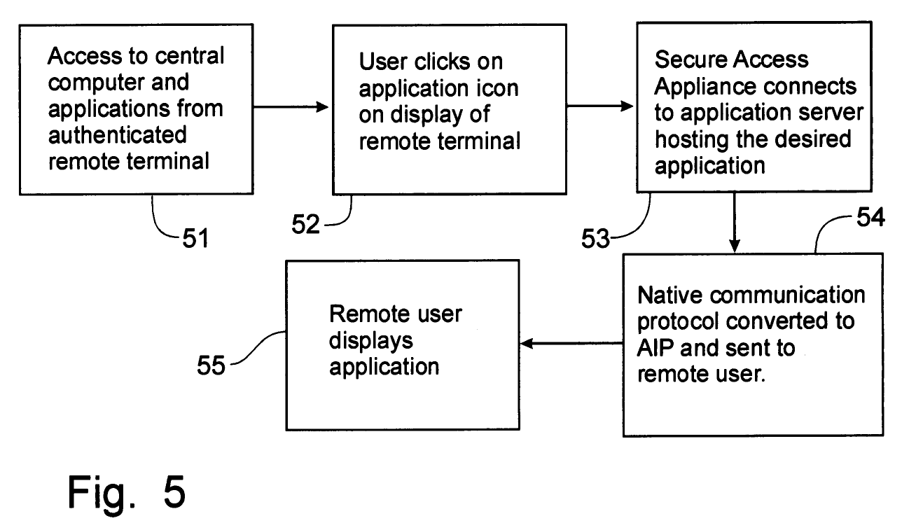

Once authenticated at the remote terminal 15 and at the secure access appliance 20, as indicated at step 51 in FIG. 5, the remote user can then click on an application icon on the display monitor of the remote terminal 15 at step 52 and be connected to the application server hosting the application or the central computer 10, as indicated at step 53. The native protocol of the application is converted to Adaptive Internet Protocol (AIP) and sent to the remote user at step 54 for display at the remote terminal 15 and use by the remote user, as indicated at step 55.

The security system provides a single integrated turnkey solution, without piecing together a myriad of technologies to provide security for the central computer. The system provides the ability for the remote user to access any software application associated with the secure access appliance without requiring any software to be installed on the remote terminal or the remote user's server.

This system provides a secure access to centralized and distributed resources for mobile workers, telecommuters, branch offices and partners. The system provides a cost effective and secure distribution of legacy applications. The utilization of Server Centric Computing moves the processing power from the remote user, and the remote terminal 15, to the central computer 10 and allows for centralized management of the data and applications on the central computer 10.

Security is enhanced by the lack of access to the IP address/name of the central computer, which remains hidden from the remote user. The remote user sees only the secure access appliance 20. Furthermore, the system guarantees the user's identity throughout the whole computing environment by use of the personal digital certificate embedded in the USB Security Key 25 to be authenticated at the remote terminal 15 and at the secure access appliance 20. In order to access the central computer 10 from the remote terminal 15, the remote user must have the USB Security Key 25 inserted into an open USB port in the remote terminal 15. If the key is stolen or lost, use of the USB Security Key 25 still requires the input of the personal identification number in order to be authenticated. Such a system is analogous to automated bank tellers (ATM), requiring both a card and a PIN in order to access the user's account.

Safeguards will deny permission to stored information such as personal digital certificates and the PIN on the remote terminal 15, as centralized management will enable. Also, the system will require the insertion of the USB Security Key in order to be authenticated for access to the appliance 20 or the central computer 10. Centralized management can also be utilized to limit access to data, to limit the printing, and to limit the storage of the data, thus providing a very secure transaction between the central computer 10 and the remote user. The secure access appliance 20 will also provide an audit trail for every transaction and communication passing through the appliance, further enhancing the centralized management of the data and applications on the central computer 10.

Centralized management via the secure access appliance 20 will also permit a limitation on the number of remote users permitted to access any particular application or data at remote terminals 15. Such a system is particularly advantageous for banks and financial institutions, which can provide a centralized management of the data of their customers while providing a secure system through which authenticated users, can access their data, which can be partitioned from other data in the central computer 10.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A security system for computer transactions with a central computer having data and software applications stored thereon comprising:
a remote terminal accessible to a network through which transactions to said central computer can be accomplished, said remote terminal having a USB port and being utilized by a remote user;
a USB Security Key embedded with a personal digital certificate unique to said remote user, said USB Security Key being insertable into said USB port on said remote terminal, said USB Security Key requiring the inputting of a personal identification number to enable access of said personal digital certificate by said remote terminal; and
a secure access appliance positioned to intercept communications from said remote terminal before reaching said central computer, said secure access appliance requiring authentication of said personal digital certificate before permitting access from said remote terminal to said central computer.

2. The security system of claim 1 wherein said remote terminal requires the authentication of said personal digital certificate embedded in said USB Security Key before access to operate the remote terminal can be granted.

3. The security system of claim 2 wherein said remote terminal is provided with an operating system to permit the activation of said remote terminal.

4. A method of securing transactions between a remote terminal and a central computer on which data is stored, comprising the steps of:
inserting a USB Security Key into a USB port on said remote terminal, said USB Security Key having a personal digital certificate embedded therein;
inputting a personal identification number into said remote terminal;
matching said personal identification number against a resident identification number stored in said USB Security Key;
if said inputted personal identification number matched the resident identification number on the USB Security Key, extracting the personal digital certificate from said USB Security Key into said remote terminal;
forwarding said personal digital certificate to an intermediate secure access appliance;
authenticating said personal digital certificate against a known Certificate Authority; and
if said personal digital certificate is authenticated, permitting access to said central computer from said remote terminal through said secure access appliance.

5. The method of claim 4 wherein said authenticating step includes the steps of:
first authenticating said personal digital certificate against said Certificate Authority before said step of forwarding said personal digital certificate to said secure access appliance; and
also authenticating said personal digital certificate by said secure access appliance against said Certificate Authority before permitting access to said central computer.

6. The method of claim 5 wherein access to said remote terminal is denied if said step of first authenticating said personal digital certificate fails.

7. The method of claim 6 wherein access to said central computer is denied if said step of also authenticating said personal digital certificate fails.

8. The method of claim 4 wherein access to said remote terminal is denied if said matching step fails.

9. The method of claim 4 wherein said central computer has an IP address/name, said secure access appliance hiding said IP address/name from said remote terminal.

10. The method of claim 4 wherein said secure access appliance provides an audit trail for all transactions passing through said secure access appliance.

11. The method of claim 4 wherein said remote terminal is prevented from storing data obtained from said central computer.

12. The method of claim 11 wherein said remote terminal can access software applications stored on said central computer.

13. A method of authenticating a user of a computer terminal having a USB port and an Internet connection, comprising the steps of:
inserting a USB Security Key into said USB port in said computer terminal, said USB Security Key having embedded therein a personal digital certificate and a resident identification number;
inputting into said computer terminal a personal identification number;
comparing said inputted personal identification number with said resident identification number in said USB Security Key;
if said personal identification number and said resident identification number match, extracting said personal digital certificate from said USB Security Key into said computer terminal; and
validating said personal digital certificate with a remote Certificate Authority over the Internet.

14. The method of claim 13 wherein the user is denied access to operate said computer terminal if said inputted personal identification number does not match said resident identification number in said USB Security Key.

15. The method of claim 14 wherein the user is denied access to operate said computer terminal if said personal digital certificate is not validated by said remote Certificate Authority.

16. The method of claim 15 wherein said computer terminal is connected to a secure access appliance when said personal digital certificate is validated by said remote Certificate Authority.

17. The method of claim 16 wherein said secure access appliance also validates said personal digital certificate against said remote Certificate Authority.

18. The method of claim 16 wherein said secure access appliance connects said computer terminal to a central computer for accessing data and software applications.

19. The method of claim 18 wherein said computer terminal is incapable of storing data in a permanent memory storage device.

20. The method of claim 19 wherein said secure access appliance shields said computer terminal from acquiring an IP address/name of said central computer.

21. A method of securing a central computer having data stored thereon from unauthorized access from a user of a remote computer terminal, comprising the steps of:
providing a secure access appliance to receive all communications to and transactions with said central computer to shield said remote computer terminal from an IP address of said central computer; and
requiring authentication of said user before granting access to said central computer through said secure access appliance.

22. The method of claim 21 wherein said requiring step comprises the steps of:
forcing said user to provide a personal digital certificate; and
authenticating said personal digital certificate against a remote Certificate Authority.

23. The method of claim 22 wherein said forcing step comprises the steps of:
inserting a USB Security Key into an open USB port in said remote computer terminal, said USB Security Key having embedded therein said personal digital certificate and a resident identification number;
inputting into said remote computer terminal a personal identification number;
comparing said inputted personal identification number with said resident identification number in said USB Security Key;
if said personal identification number and said resident identification number match, extracting said personal digital certificate from said USB Security Key into said computer terminal; and
forwarding said personal digital certificate to said secure access appliance for authentication.

24. The method of claim 23 further comprising the step of:
validating said personal digital certificate with said remote Certificate Authority over the internet before said forwarding step, said user being denied access to operate said remote computer terminal if said validating step fails.

25. The method of claim 24 wherein said remote computer terminal is designed specifically without moving parts such as a hard drive, and when used in conjunction with a central computer eliminates the need to store data on a permanent memory storage device at said remote computer terminal.
